(19) United States
(12) Patent Application Publication
(10) Pub. No.: US 2013/0188268 A1
(43) Pub. Date: Jul. 25, 2013

(54) RETRACTABLE LENS BARREL

(71) Applicant: TAMRON CO., LTD., Saitama-shi (JP)

(72) Inventors: Yasuhiro HATAKEYAMA, Saitama-shi (JP); Hisashi Sutoh, Saitama-shi (JP)

(73) Assignee: TAMRON CO., LTD., Saitama-shi (JP)

(21) Appl. No.: 13/713,730

(22) Filed: Dec. 13, 2012

(30) Foreign Application Priority Data
Jan. 23, 2012 (JP) 2012-011353

(51) Int. Cl. G02B 7/02

(52) U.S. Cl. CPC G02B 7/021
USPC 359/813

(57) ABSTRACT

In a retractable lens barrel, during imaging, when a drive unit is driven accompanying the extension of the retractable lens barrel, a first lens and a second lens are moved along the optical axis to maintain a given interval between the first lens and the second lens, a rotating member rotates in a given direction and rotates centered about a line parallel to the optical axis, whereby a first optical element is inserted onto the optical axis. The second lens is moved such that a second optical element remains positioned on the optical axis. In this state, the entrance of outside light, which can cause image formation to be negatively affected, is prevented by the rotating member and a base member. Thus, light entering the inside of the retractable lens barrel is limited to the light transmitted by the first optical element and necessary for image formation.

### BACKGROUND OF THE INVENTION

1. Field of the Invention

The present invention relates to a retractable lens barrel and in particular, related to a retractable lens barrel that when retracted, a portion of a lens resides off the optical axis and overlaps another lens along a direction of the optical axis.

2. Description of the Related Art

Recently, accompanying emphasis on portability, smaller and thinner imaging apparatuses are demanded. To meet these demands, reductions are necessary in the size and thickness of the imaging lenses, which are principal elements in determining the thickness of the imaging apparatus. Thus, retractable lens barrels, which can stow lenses inside the imaging apparatus when not in use, are widely employed.

Conventional retractable lens barrels that are widely used reduce, on the optical axis of the lenses, the interval between lenses when stowing the lenses, where the thickness of the lenses and the number of lenses determine the thickness of the lens barrel when retracted. Therefore, the extent to which the size and thickness of the lens barrel can be reduced is limited. To address this problem, lens barrels have been proposed that when retracted have a thinner thickness achieved by moving a portion of the lenses off of the optical axis when the lens barrel is in a retracted state (see, for example, Japanese Patent Application Laid-Open Publication Nos. 2005-266345, 2006-300992, and 2007-4038)

The lens barrel disclosed in Japanese Patent Application Laid-Open Publication No. 2005-266345 has multiple optical elements forming an imaging optical system, where during an imaging state, the optical elements are positioned on the same imaging optical axis and during a retracted state, a portion of the optical elements are stowed at a position off of the optical axis of the other optical elements; and the stowed optical elements and at least a portion of the other optical elements remaining on the imaging optical axis are alternated. In particular, among at least a portion of the optical elements remaining on the imaging optical axis, are linearly moving optical elements that in the imaging state, are moved along the optical axis without changing the distance along the optical axis with respect to the optical element subject to stowing during retraction. During transition from the imaging state to the retracted state, at least a portion of the stowed elements and a portion of the linear moving elements are positioned within the same plane, which is orthogonal to the imaging optical axis.

The lens barrel disclosed in Japanese Patent Application Laid-Open Publication No. 2006-300992 has an imaging optical system formed by multiple lens groups, and multiple barrel members that support the imaging optical system as well as extend and retract the lens barrel. When the barrel members are in a retracted state, a given lens group among the lens groups is inside the barrel while the other lens groups are stowed at a position different from the optical axis. In particular, each lens group positioned between the object side and image side of the imaging optical system is stowed to a position different from the optical axis without changing the positioning relationship with a light controlling member controlling the amount light from the object, transmitted by the imaging optical system.

The lens barrel (optical unit) disclosed in Japanese Patent Application Laid-Open Publication No. 2007-4038, when in the process of retracting, inverts a cam-cylinder, laterally stows a lens of a 2-group lens frame from between lenses of a 1-group and a 3-group lens frames, and subsequently overlaps the lens of the 2-group lens frame with one or both of the lenses of the 1-group lens frame and the 3-group lens frame.

The lens barrels above each stow a portion lenses at a position off of the optical axis when retracted and at the some time, reduce the interval between the lenses remaining on the optical axis to thereby reduce a dimension (thickness) along the optical axis.

However, the lens barrels disclosed in Japanese Patent Application Laid-Open Publication Nos. 2005-266345 and 2006-300992 have a problem in that consequent to a base member supporting the stowed lenses being positioned to not overlap other elements along a direction orthogonal to the optical axis, the thickness in the retracted state is increased by an amount equivalent to the thickness of one base member, preventing further reductions.

To reduce the thickness by the amount equivalent to the thickness of one base member, conventionally, a recess is provided in the base member to enable rotation of the stowed lens. However, when the lens barrel is used, extraneous outside light enters from the recess, negatively affecting image formation and causing another problem. To solve this problem, a light blocking member has to be additionally provided, making the lens barrel structure complicated and increasing manufacturing costs.

Further, with the lens barrel disclosed in Japanese Patent Application Laid-Open Publication No. 2007-4038, to further reduce the thickness of the barrel when the lenses are stowed, an insertion opening for housing the stowed lenses is provided in a lens frame that holds lenses that are not stowed away from the optical axis. However, the formation of such an insertion opening results in extraneous light entering during imaging, which negatively affects image formation.

### SUMMARY OF THE INVENTION

It is an object of the present invention to at least solve the above problems in the conventional technologies.

A retractable lens barrel according to one aspect of the present invention includes a first lens having a first optical element, a rotating member that is a substantially circular plate, rotates about, as a center, a line parallel to the optical axis, and holds the first optical element at a position distal to the center of rotation, a base member that has a ring-shape and is embedded in the rotating member, and a drive unit that has a ring-shape and supplies a rotational force to the rotating member; and a second lens having a second optical element that is disposed on the optical axis, and an optical element frame that holds the second optical element. The first lens and the second lens are disposed adjacently, enabling an interval along a direction of each other's optical axis to be changed. The first optical element and the base member are disposed such that at least a portion of the first optical element and a portion of the base member overlap in a plane that is substantially orthogonal to the optical axis. During imaging and accompanying extension, the rotating member rotates consequent to driving of the drive unit, the first optical element is inserted onto the optical axis, and outside light that does not enter the first optical element, is at risk of negatively affecting image formation, and is from the object side is blocked by the rotating member and the base member. During non-use and accompanying retraction, the rotating member rotates consequent to driving of the drive unit, the first optical element is stowed off of the optical axis, the portion of the first lens and the portion of the second lens overlap along a direction substantially orthogonal to the optical axis.

The other objects, features, and advantages of the present invention are specifically set forth in or will become apparent from the following detailed description of the invention when read in conjunction with the accompanying drawings.

### BRIEF DESCRIPTION OF THE DRAWINGS

FIGS. 1A and 1B are exploded views of principal elements of the lens barrel according to the present invention;

FIG. 2 is a cross sectional view along the optical axis and depicts a configuration of the first lens 110;

FIGS. 3A and 3B are diagrams for describing the retractable lens barrel according to the invention, in an imaging (extended) state; and

FIGS. 4A and 4B are diagrams for describing the retractable lens barrel unit in a non-imaging (retracted) state.

### DETAILED DESCRIPTION OF THE PREFERRED EMBODIMENTS

With reference to the accompanying drawings, preferred embodiments of a retractable lens barrel according to the present invention will be described in detail.

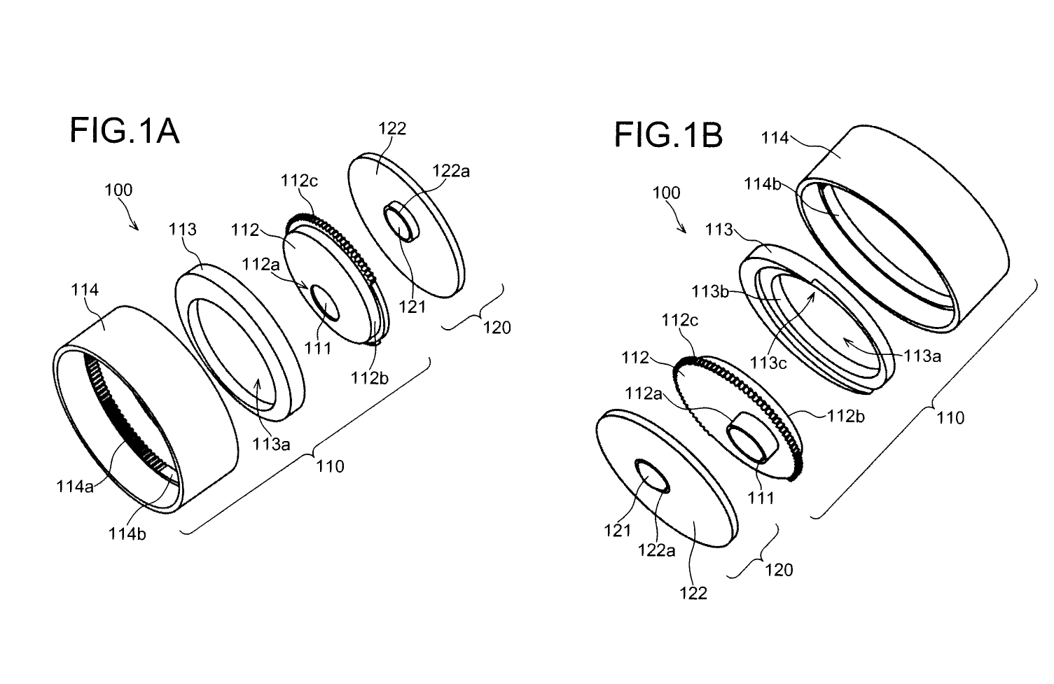

FIGS. 1A and 1B are exploded views of principal elements of the lens barrel according to the present invention. FIG. 1A is a view from the object side of the lens barrel; FIG. 1B is a view from the image side of the lens barrel.

This retractable lens barrel 100 includes a first lens 110 and a second lens 120. The first lens 110 is configured by a first optical element 111, a rotating member 112, a base member 113, and a drive unit 114. The second lens 120 is configured by a second optical element 121 and an optical element frame 122. The first optical element 111 and the second optical element 121 are configured by a lens, a filter, etc.

The rotating member 112 is formed by a substantially circular plate in which an opening 112a is formed at a position closer to the periphery than a center portion. The first optical element 111 is held in the opening 112a. At the outer periphery of the rotating member 112, an outer step 112b is formed. Further, at a portion of the outer periphery of the rotating member 112, outer teeth 112c are disposed.

The base member 113 has a ring-shape in which an embedding hole 113a is formed to embed the rotating member 112 at a position significantly biased from a central portion. Along the inner periphery of the base member 113, an inner step 113b is formed. The inner step 113b abuts the outer step 112b, when the rotating member 112 is embedded in the embedding hole 13a. At a portion of the outer periphery of the base member 113, a recess 113c is formed so that the outer teeth 112c protrude when the rotating member 112 is in an embedded state.

The drive unit 114 also has a ring-shape and along a portion of the inner periphery, inner teeth 114a are disposed. The inner teeth 114a engage with the outer teeth 112c when the rotating member 112 is embedded in the base member 113 and the base member 113 is thus embedded in the drive unit 114. Along a portion of the inner periphery of the drive unit 114, a sliding unit 114b is disposed. The sliding unit 114b supports the base member 113 while sliding with respect to the outer peripheral surface of the base member 113, when the drive unit 114 is driven.

The optical element frame 122 is configured by a substantially circular plate in which an opening 122a is formed. The optical element frame 122 is positioned such that the optical axis passes through the center of the opening 122a. The optical axis substantially coincides with the cylinder axis of the retractable lens barrel 100. The opening 122a holds the second optical element 121.

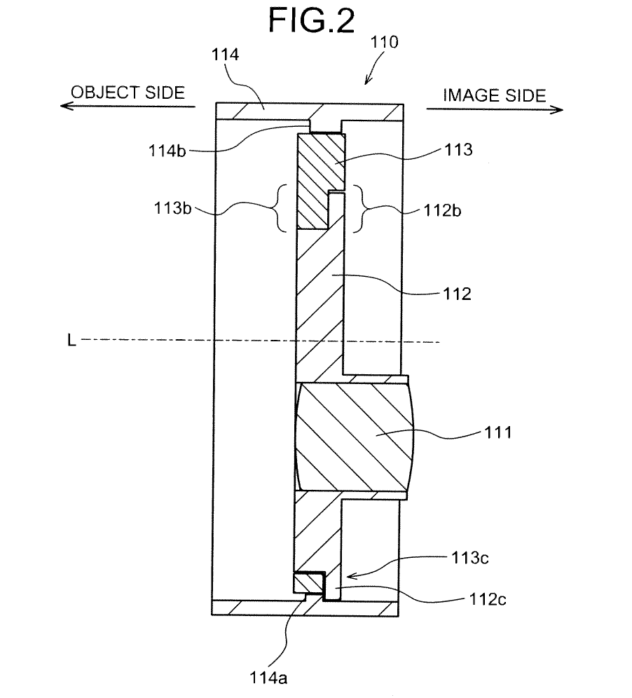

FIG. 2 is a cross sectional view along the optical axis and depicts a configuration of the first lens 110. In FIG. 2, the left-hand side represents the object side. The first lens 110 has a configuration in which the rotating member 112, which holds the first optical element 111, is embedded in the base member 113 and the base member 113 is further embedded in the drive unit 114.

In this state, the outer step 112b of the rotating member 112 abuts the inner step 113b of the base member 113. The first optical element 111 is positioned to overlap a portion of the base member 113 in a plane that is substantially orthogonal to the optical axis. Near the outer step 112b and the inner step 113b, the position of a surface that is of the rotating member 112 and faces the object side, and the position of a surface that is of the base member 113 and faces the object side, coincide in a plane that is substantially orthogonal to the optical axis. The position of a surface that is of the rotating member 112 and faces the imaging side, and the position of a surface that is of the base member 113 and faces the image side, also coincide in a plane that is substantially orthogonal to the optical axis. The sliding unit 114b supports the base member 113 such that the base member 113 does not separate from the inner periphery of the drive unit 114. The rotating member 112 can rotate with respect to the base member 113 and during this rotation, the axis of the rotation is a line L that is parallel to and significantly away from the optical axis.

In this state, the outer teeth 112c of the rotating member 112 protrude from the recess 113c of the base member 113 and engage with the inner teeth 114a of the drive unit 114. Consequently, the rotating member 112 rotates interlocked with a driving of the drive unit 114, i.e., when the drive unit 114 is driven to extend or retract the retractable lens barrel 100, interlocked with the movement of the drive unit 114, the rotating member 112 rotates about the line L and the first optical element 111 is inserted onto the optical axis or is stowed off of the optical axis. However, the position of the base member 113 does not change.

As described, since the outer step 112b of the rotating member 112 abuts the inner step 113b of the base member 113, even if the rotating member 112 rotates with respect to the base member 113, the rotating member 112 is prevented from being displaced along a direction of the optical axis and from being separated from the base member 113. In other words, the inner step 113b has a function of a positioner controlling the movement of the rotating member 112 along a direction of the optical axis.

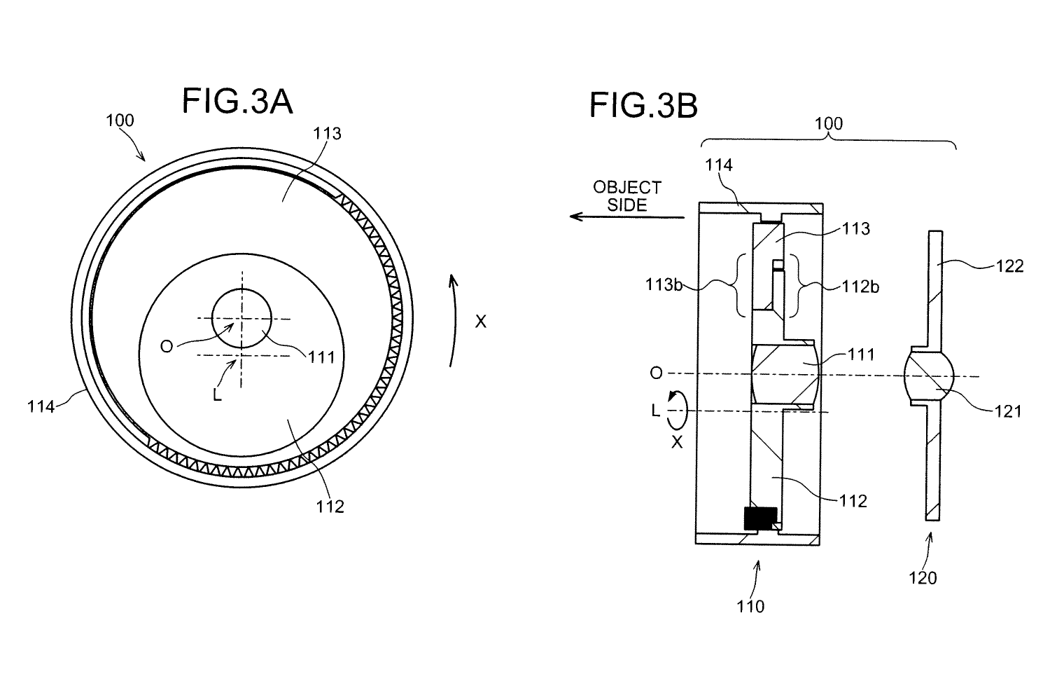

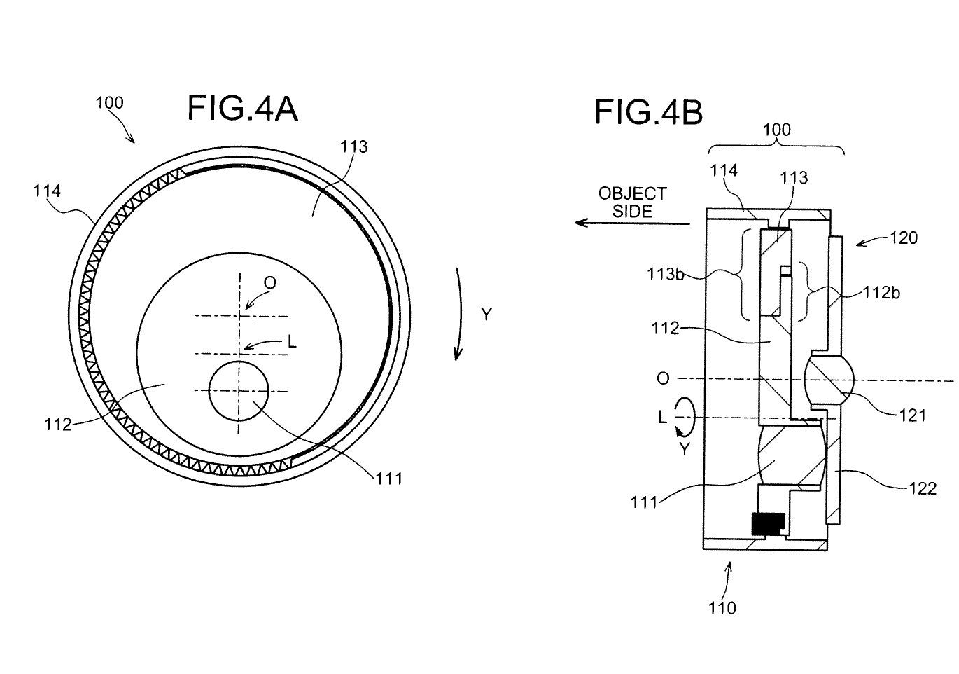

Operation of the retractable lens barrel according to the present embodiment will be described. FIGS. 3A and 3B are diagrams for describing the retractable lens barrel according to the invention, in an imaging (extended) state. Further, FIGS. 4A and 4B are diagrams for describing the retractable lens barrel unit in a non-imaging (retracted) state. FIGS. 3A and 4A are front views, as viewed from the object side of the retractable lens barrel 100; and FIGS. 3B and 4B are cross sectional views along the optical axis, depicting the configuration of primary elements of the retractable lens barrel 100. Further, in FIGS. 3B and 4B, the left-hand side is the object side.

During imaging, the drive unit 114, accompanying an extension of the retractable lens barrel 100, rotates in the direction indicated by arrow X in FIG. 3A. Accordingly, as depicted in FIG. 30, the first lens 110 and the second lens 120 are respectively moved along a direction of the optical axis O to maintain a given interval between the first lens 110 and the second lens 120 as the rotating member 112 rotates in the direction indicated by arrow X and rotates centered about the line L parallel to the optical axis O, whereby the first optical element 111 is inserted onto the optical axis O. The second lens 120 is moved such that the second optical element 121 remains positioned on the optical axis O. Further, the cylinder axis of the retractable lens barrel 100 and the optical axis O substantially coincide. Consequently, compared to the lens barrel disclosed in Japanese Patent Application Laid-Open Publication No. 2007-4038, a dimension of the lens barrel, along a direction of the diameter, can be effectively used.

In the present invention, since space consequent to a through-hole and for accommodating the first optical element 111 when stowed off of the optical axis O (described in detail hereinafter) is not provided in either the rotating member 112 positioned on the object side of the retractable lens barrel 100 or the base member 113, the entrance of outside light, which can cause image formation to be negatively affected, is prevented by the rotating member 112 and the base member 113. Therefore, light entering the inside of the retractable lens barrel 100 is limited to the light transmitted by the first optical element 111 and necessary for image formation.

Meanwhile, during non-use, the drive unit 114, accompanying a retraction of the retractable lens barrel 100, rotates in the direction indicated by arrow Y in FIG. 4A. Accordingly, as depicted in FIG. 4B, the first lens 110 and the second lens 120 are respectively moved along the direction of the optical axis O to reduce the interval between the first lens 110 and the second lens 120 as the rotating member 112 rotates in the direction indicated by arrow Y and rotates centered about the line L parallel to the optical axis O, whereby the first optical element 111 is stowed off of the optical axis O. When the first optical element 111 reaches the stowing position, a surface that is of the first optical element 111 and faces the imaging side comes in contact with a surface that is of the optical element frame 122 of the second lens 120 and that faces the object side.

In other words, a portion of the first lens 110 and a portion of the second lens 120 overlap along a direction that is substantially orthogonal to the optical axis O. Consequently, when the retractable lens barrel 100 is retracted, the distance between the first lens 110 and the second lens 120 can be minimized. Therefore, even if space consequent to a through-hole and for accommodating the first optical element 111 when stowed off of the optical axis O is not provided, reductions in the thickness of the retractable lens barrel 100 in a retracted state are not hindered.

As described, in the present invention, with a simple configuration, the rotating member 112, accompanying the extension and retraction of the retractable lens barrel 100, rotates about the line L parallel to the optical axis O, whereby the first optical element 111 can be stowed from a position on the optical axis O to a position off of the optical axis O. In addition, since no space consequent to a through-hole and for accommodating the first optical element 111 when stowed off of the optical axis O is provided, there is no risk of extraneous outside light entering the inside of the lens barrel from the space and negatively affecting image formation.

Further, in the retractable lens barrel 100 according to the present invention, when the first optical element 111 is in a state of being stowed off of the optical axis O, a portion of the first lens 110 and a portion of the second lens 120 overlap along a direction substantially orthogonal to the optical axis o, whereby the distance can be minimized between the first lens 110 and the second lens 120 when the lens barrel is retracted, even if space consequent to a through-hole and for accommodating the first optical element 111 is not provided. Thus, the retractable lens barrel 100 facilitates reductions in the thickness (length) of the lens barrel when in a retracted state.

In particular, in the retractable lens barrel 100 according to the present invention, the first optical element 111 is held by the rotating member 112 and has the outer teeth 112c disposed at the outer periphery; the recess 113c is formed from which the outer teeth 112c protrude when the rotating member 112 is embedded in the base member 113; and the inner teeth 114a are disposed, which engage with the outer teeth 112c when the base member 113 is embedded in the drive unit 114. Thus, the rotating member 112 rotates smoothly about the line L, interlocked with the movement of the drive unit 114; and the first optical element 111 can be stowed from a position on the optical axis O to a position off of the optical axis O.

Moreover, in the retractable lens barrel 100 according to the present invention, when the rotating member 112 is embedded in the base member 113, the outer step 112b of the rotating member 11 abuts the inner step 113b of the base member 113. Consequently, the inner step 113b acts as a positioner controlling the movement of the rotating member 112 along a direction of the optical axis O and even if the rotating member 112 rotates with respect to the base member 113, the rotating member 112 will not be displaced along a direction of the optical axis O and will not become separated from the base member 113.

In the embodiment, for convenience in description, only the first lens 110 and the second lens 120 are depicted. Nonetheless, a third lens, a fourth lens, etc. having a function identical to that of the second lens 120 may be disposed on the image side of the second lens 120. Further, although not depicted in the figures, a motor and the like is used as a driving source to control the extension/retraction of the retractable lens barrel 100.

As described, the retractable lens barrel according to the present invention facilitates reductions in a dimension of thickness when retracted and can prevent the entrance of outside light that is at risk of negatively affecting image formation; and in particular, the retractable lens barrel is optimal for an imaging apparatus of which reductions in size are desirable.

The present invention enables a retractable lens barrel to be provided that has a simple configuration, facilitates reductions in a dimension of thickness when retracted, and prevents the entrance of external light that is at risk of negatively affecting image formation.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

The present document incorporates by reference the entire contents of Japanese priority document, 2012-011353 filed in Japan on Jan. 23, 2012.

What is claimed:

1. A retractable lens barrel comprising:
a first lens having
a first optical element,
a rotating member that is a substantially circular plate, rotates about, as a center, a line parallel to an optical axis, and holds the first optical element at a position distal to the center of rotation,
a base member that has a ring-shape and is embedded in the rotating member, and
a drive unit that has a ring-shape and supplies a rotational force to the rotating member; and
a second lens having
a second optical element that is disposed on the optical axis, and
an optical element frame that holds the second optical element, wherein
the first lens and the second lens are disposed adjacently, enabling an interval along a direction of each other's optical axis to be changed,
the first optical element and the base member are disposed such that at least a portion of the first optical element and a portion of the base member overlap in a plane that is substantially orthogonal to the optical axis,
during imaging and accompanying extension, the rotating member rotates consequent to driving of the drive unit, the first optical element is inserted onto the optical axis, and outside light that does not enter the first optical element, is at risk of negatively affecting image formation, and is from the object side is blocked by the rotating member and the base member, and
during non-use and accompanying retraction, the rotating member rotates consequent to driving of the drive unit, the first optical element is stowed off of the optical axis, the portion of the first lens and the portion of the second lens overlap along a direction substantially orthogonal to the optical axis.

2. The retractable lens barrel according to claim 1, wherein a cylinder axis of the retractable lens barrel and the optical axis substantially coincide.

3. The retractable lens barrel according to claim 1, wherein the rotating member has an opening that holds the first optical element,
the base member has an embedding hole to embed the rotating member.

4. The retractable lens barrel according to claim 2, wherein the rotating member has an opening that holds the first optical element,
the base member has an embedding hole to embed the rotating member.

5. The retractable lens barrel according to claim 1, wherein the base member has a positioner that controls movement along a direction of the optical axis.

6. The retractable lens barrel according to claim 2, wherein the base member has a positioner that controls movement along a direction of the optical axis.

7. The retractable lens barrel according to claim 3, wherein the base member has a positioner that controls movement along a direction of the optical axis.
